(19) United States
(12) Patent Application Publication
(10) Pub. No.: US 2017/0080429 A1
(43) Pub. Date: Mar. 23, 2017

(54) MEDIA SUPPLY DEVICE

(71) Applicant: WALDNER LABOREINRICHTUNGEN GMBH & CO. KG, Wangen im Allgäu (DE)

(72) Inventor: Jürgen Liebsch, Lindenberg (DE)

(73) Assignee: WALDNER LABOREINRICHTUNGEN GMBH & CO. KG, Wangen im Allgäu (DE)

(21) Appl. No.: 15/126,174

(22) PCT Filed: Mar. 16, 2015
(86) PCT No.: PCT/EP2015/025014

§ 371 Date: Sep. 14, 2016

(30) Foreign Application Priority Data
Mar. 17, 2014 (DE) 10 2014 103 620.4

(51) Int. Cl. B01L 9/02; H02G 3/04; F16L 3/127; H02G 11/00; F16L 3/18; F16L 3/26

(52) U.S. Cl. CPC B01L 9/02; F16L 3/18; F16L 3/26; F16L 3/127; H02G 11/00; H02G 3/0493

(57) ABSTRACT

The present invention relates to a media supply device for barrier-free, selective supply of laboratory media to at least one school or laboratory workstation. The media supply device comprises a body and a multiplicity of fittings for the supply and removal of laboratory media, which fittings are adjustable in height relative to the body and are coupled to the latter, and it is characterized in that the coupling between the fittings and the body is such that the fittings are movable in rotation about at least one oblique rotation axis deviating from a horizontal and vertical rotation axis.

### RELATED APPLICATIONS

The present application is a National Phase entry of PCT Application No. PCT/EP2015/025014, filed on Mar. 16, 2015, which claims priority to DE Patent Application No. 10 2014 103 620.4, filed on Mar. 17, 2014, which are hereby fully incorporated herein by reference.

### TECHNICAL FIELD

The present invention relates to a media supply device for barrier-free, selective supply of at least one school or laboratory workstation with laboratory media, comprising a body and numerous fittings that can be adjusted in terms of height in relation to the body, and coupled thereto, for the supply and removal of laboratory media.

### BACKGROUND

The demands to modern laboratory spaces have increased significantly in recent years, and are currently determined by, among others, the following factors: absence of barriers, flexibility in the supplying of media, modularity, adaptability to changes in the assignment of tasks and equipment, and low provision costs through efficient exploitation of the height of the room and the laboratory space. Conditional to these factors, which are not to be understood as exclusive, concepts have been developed that enable the supply of laboratory media to the laboratory workspaces from above, without connection to the floor. Supplying media from above via the ceiling has numerous advantages. On one hand, the floor space of the laboratory remains free of media connections, and as a result, to a certain extent, the optimization of work flow in the laboratory workspaces can be altered, and the other furnishings normally needed in the laboratory can be redistributed, at any time. On the other hand, supplying media via the ceiling allows for a simple subsequent adaptation of the laboratory layout to modified laboratory conditions, if, for example, an inorganic laboratory is to be changed into a biochemical or physical laboratory. All of this is possible without any significant alterations to the laboratory space and the laboratory buildings.

Regarding the removal of the laboratory media supplied from above via the ceiling, there are basically two systems. On one hand, there are pathway-based media supply systems, which are also referred to as service wings, and which enable the supplying of media to laboratory workspaces disposed along the pathways. Selective supply systems belong to the second category. These systems supply just one workspace or a group of, e.g. 2 or 3, adjacent workspaces, spaced closely together, with laboratory media. There are, however, combinations of pathway-based and selective media supply systems. The present invention relates to selective supply systems.

Selective supply systems that are attached to the ceiling, or potentially to a suspended ceiling, are widely known. These selective supply systems have removal fittings, which are either located at an established height beneath the ceiling (e.g. media columns) or can be adjusted in terms of height. With the height adjustable systems known from the prior art, a lowering of the media fittings occurs in different ways. Thus, there are systems that lower the media connection via a pantograph, telescoping guide or a hinge that allows for a pivotal movement about a horizontal axis, and raise it again when not in use. In this context, reference is made to EP 2 367 248 A2 and EP 1 916 749 B1. In medical practices and clinical spaces, such as an operating theater, for example, systems are used that have arms connected to one another in an articulated manner and can thus be pivoted vertically and horizontally. There are frequently monitors and shelves, as well as electric and EDP connections, in the region of the free ends of these articulated arms. The lamps that are usually seen in dental practices above the dentist chair can also be moved to nearly any position above the dentist chair via such an articulated arm assembly.

The present invention represents an alternative to the selective media supply systems known from the prior art. This is achieved by means of the present invention having the combination of features in claim 1. Optional or preferred features of the invention are given in the dependent claims 2 to 18.

In accordance with the invention, a media supply device for a barrier-free, selective supplying of at least one school or laboratory workspace with laboratory media is created. The media supply device comprises a body and numerous fittings thereby, which can be adjusted in terms of height in relation to the body, and are coupled thereto, for the supply and removal of laboratory media. It is characterized in that the coupling between the fittings and the body is such that the fittings can be rotated about at least one oblique rotational axis, deviating from a horizontal and vertical axis of rotation.

In accordance with a preferred embodiment of the invention, the fittings can rotate about at least one horizontal, at least one vertical, and numerous oblique axes of rotation.

The fittings can preferably move in the manner of a nozzle.

According to an advantageous further development of the invention, the fittings can be adjusted in relation to the body to numerous predetermined heights.

The fittings are preferably height-adjustable in relation to the body in a continuously variable manner.

Furthermore, the fittings can preferably rotate at any height.

According to another preferred embodiment of the invention, the fittings are coupled to the body such that they are not subjected to a tension.

It is furthermore advantageous when the fittings are accommodated in a housing that is coupled to the body.

It is even more advantageous when the body has a cavity in which the housing can be at least partially received.

The housing and the body are preferably coupled by means of numerous annular elements, wherein adjacent annular elements are connected to one another such that they can rotate.

The rotational motion of the adjacent annular elements is preferably achieved by means of a ball and socket joint.

It is even more preferred that the numerous annular elements form a closed sheath.

According to an advantageous further development of the invention, the fittings are connected to the laboratory media lines, both for conducting fluids as well as electricity, which lines run inside the numerous annular elements.

According to another preferred embodiment of the invention, the body has an opening, through which at least a portion of the numerous annular elements can move.

It is further preferred that a chain is accommodated in the body, which is flange-mounted to an annular element, and that the height of the fittings can be adjusted by means of a horizontal movement of the chain.

It is advantageous when the media supply device also comprises a force sensor, which detects the force acting on the fittings, wherein, if the detected force exceeds a predetermined threshold value, the supply of laboratory media to the fittings is interrupted.

It is particularly advantageous that the body is designed to be attached to a ceiling or a wall of a room.

It is even more preferred that the fittings comprise at least two, preferably three or four or five or six or seven or eight or nine or ten laboratory media fittings, selected from the group composed of gas, pure gas, water, compressed air, electricity, EDP, multimedia, light, vacuum and exhaust air fittings.

### BRIEF DESCRIPTION OF THE FIGURES

The invention shall now be explained, purely by way of example, based on FIG. 1 through FIG. 4, which depict a preferred embodiment of the invention. Therein:

FIG. 1 shows a side view of a media supply device, in which the fittings for the supply and removal of laboratory media are shown in a retracted position,

FIG. 2 shows a side view of the media supply device shown in FIG. 1, in which the fittings are disposed in an extended position,

FIG. 3 shows a top view of the media supply device shown in FIGS. 1 and 2, and

FIG. 4 shows a bottom view of the fittings.

### DETAILED DESCRIPTION OF EMBODIMENTS

Because there is no generally applicable or official definition of the term “laboratory media,” laboratory media is understood, as set forth in the invention, to mean the media that are needed and supplied in a laboratory, and also in a natural sciences or a domestic sciences instructional space of a school. These laboratory media include not only gaseous or liquid substances, but also such media that are of an electrical nature. These include, for example, current and analog or digital electrical data. But not only laboratory media that are supplied to a laboratory or school workspace, belong to the laboratory media as set forth in the invention. Instead, the term “laboratory media” should also be understood to mean such media that must be removed from a laboratory or school workspace, such as waste water and exhaust air.

As has already been mentioned in the introductory portion of the description, the term “selective” should indicate a distinction from the pathway-based media supply systems. But also, comprehensive media supply systems, e.g. the media ceiling, which provide a distribution of the laboratory media from a building-side provision station over the entire laboratory space, and comprehensively distributed removal stations for the laboratory media in the region of the ceiling are to be distinguished from selective media supply systems. The term “selective” is not be understood in the mathematical sense, because a selective supply always has, as a matter of course, a limited spatial range in the macroscopic world. A workspace or closely packed workspaces are to be supplied with laboratory media by means of a supply system acting in a selective manner.

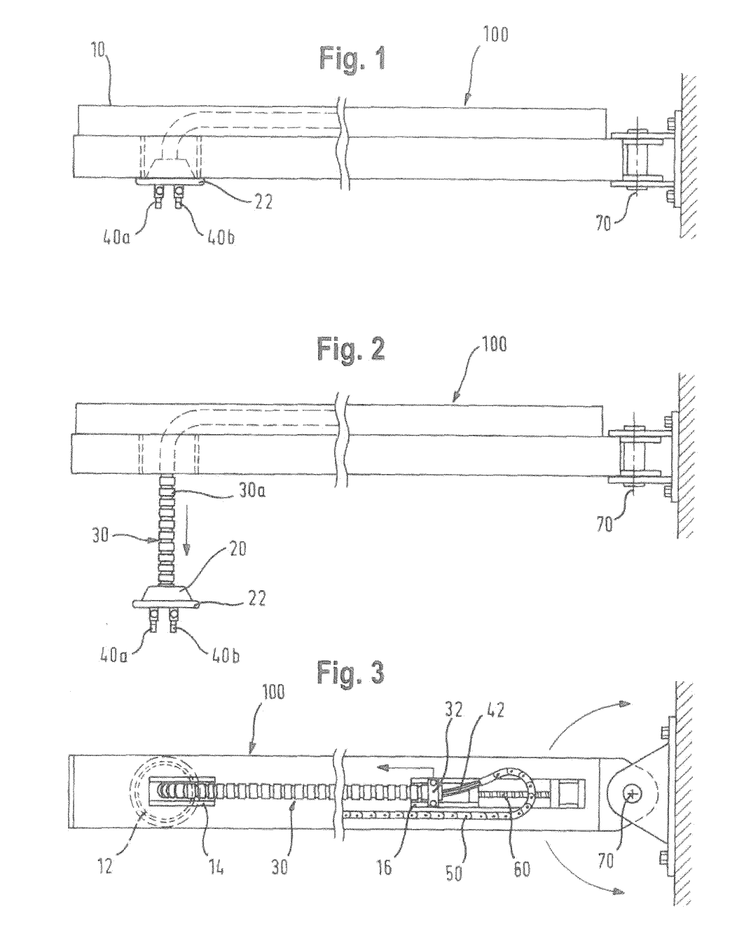

The media supply device 100 shown in the figures serves primarily as the barrier-free, selective supply means of laboratory media to at least one school or laboratory workspace. The media supply device 100 is attached to either a wall (as in FIG. 1) or a ceiling of a room for this purpose, regardless of whether this is a ceiling of a room, or a suspended ceiling. When the media supply device is attached to a ceiling of a room, it is preferably attached by means of an appropriately designed mounting bracket. This attachment can also comprise a joint 70 depicted in FIG. 1, which allows for rotation in a horizontal plane. The range of motion of the media supply device in the horizontal direction is increased by means of this rotational movement in comparison to a rigid, stationary attachment to the wall or ceiling of the room.

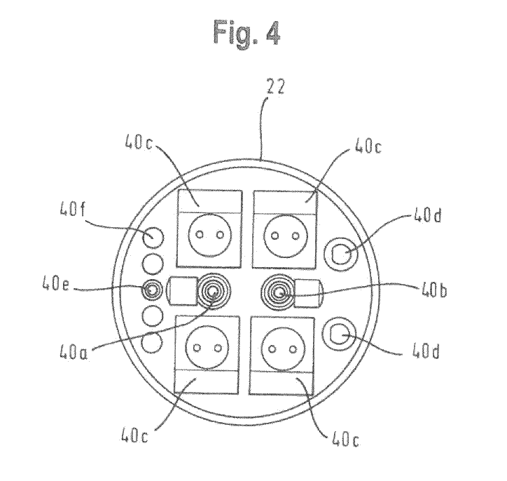

As can be seen in FIG. 4, the media supply device 100 has numerous fittings 40a-40f for the various laboratory media, which are accommodated in the exemplary embodiment shown here in a bowl-shaped housing 20 having a circular cross section. In the exemplary embodiment shown, a total of four sockets 40c are provided, of which, in each case, two sockets are disposed in a row. The sockets can be those designed for low voltage (e.g. 230V and 400V in Germany). Fittings 40a, 40b for gaseous and aqueous media are disposed between the sockets 40c in the exemplary embodiment shown, each of which has a stopcock, such that the supply of gas and water can be activated and deactivated manually. Furthermore, two network connections 40d, which are also understood to be fittings as set forth in the invention, are depicted at the right in FIG. 4. On the left-hand side in FIG. 4, further connections 40e, 40f can be seen, e.g. for providing light, compressed air and a vacuum. It is expressly stated at this point that the invention is not limited to the arrangement of fittings shown in FIG. 4, and the type of fittings specified explicitly herein. Instead, any type of fitting, and preferably in a modular manner, can be provided, which may be used for the supplying and removal of the laboratory media described in greater detail above.

With reference to FIG. 2, the bowl-shaped housing 20 is connected to a caterpillar-like, tube-shaped element 30, which comprises numerous annular elements 30a. The tube 30 is a tube-shaped assembly composed of numerous annular elements 30a, each having a convex surface, and preferably connected to one another via a ball and socket joint, which is not shown.

As a result, the tube 30 can move in every extended position, i.e. in each height, outside the body 10, in a three-dimensional manner, similar to a nozzle. In other words, the tube nozzle 30 can rotate not only about the horizontal and vertical axes, but also about oblique axes of rotation, including those that change in terms of their location with the movement. A three-dimensional freedom of motion of the nozzle 30 of this type offers a maximum flexibility with respect to accessibility and manipulation of the media supply device 100.

The lowest annular element 30a shown in FIG. 2 is connected to the housing 20, while the annular element 30a disposed at the opposite, free end of the tube-shaped element 30 is flange connected to a chain 50. The laboratory media lines 42, which are in a fluid-conducting connection with the fittings 40a-40f, run inside the nozzle-like tube 30, and inside the chain 50, which is also referred to as an energy chain, and can be connected to building-side supply connections or the media transfer points of a media ceiling.

The body 10 has a cavity, into which the bowl-shaped housing 20 can be inserted or accommodated at least in part. Preferably there is a rubber ring 22 located on the lower edge of the bowl-shaped housing 20, which is slightly compressed when in a retracted state, and thus provides for a firm securing of the housing 20 in the cavity. The rubber ring 22 also serves as a protection against head injuries in each extended position of the tube 30 in the event that a person unintentionally comes in contact with the housing 20.

There is a redirection of the nozzle-like tube 30 inside the body 10 shown in FIG. 1 and FIG. 2, preferably having a rectangular cross section, which preferably forms a closed sheath surface. In the region of the redirection, the body 10 preferably has a convex surface, in order to ensure a uniform (and smooth) raising and lowering of the tube 30 together with the housing 20 and the fittings 40a-40f located therein, through the opening 12 provided on the undersurface of the body 10. By way of example, an electric motor-driven spindle drive 60 may provide for a translational movement of the section of the tube 30 that runs inside the body 10. Preferably, a pneumatic lifting cylinder may also be used as the drive for the lowering and raising of the tube 30. In order to enable a lowering of the tube 30 in a straight line, to the greatest extent possible, the body 10 has a guide 14 in the region of the redirection point, formed by parallel, spaced apart, vertical plates.

The media supply device 100 also preferably has a safeguard against vandalism. If, for example, a force is exerted on the housing 20, or the tube-shaped nozzle 30, which lies above a predetermined threshold value, a force sensor, not shown in the drawings, detects and measures this force, and causes all of the fittings 40a-40f to be deactivated via an intermediary control. In the deactivated state, the sockets 40c or other electrical fittings 40d, 40e, 40f receive no voltage, and all of the fittings 40a, 40b for gas and liquid laboratory media are closed, for example. In the deactivated state, therefore, no supplying or removal of laboratory media occurs via the media supply device 100.

It is also important that by means of the coupling of the housing 20 via the nozzle-shaped or nozzle-like tube 30 to the body 10, a tension relief is ensured for all of the media lines 42 running inside the tube 30. This tube 30, the sheath of which is preferably closed, thus guides, protects and supports all of the media lines 42 running therein.

With the preferred embodiment example shown herein, the distance that the housing 20 and thus the fittings 40a-40f can be lowered in relation to the body 10 is ca. 400 mm. The fittings 40a-40f can thus be lowered to a working height of ca. 1.50 m above the floor, and can also be reached by short persons. The length of the body 10, in the horizontal direction in the exemplary embodiment shown herein, is preferably 1.50 m.

The removal of media is preferably possible at each height. Likewise, the downward and upward movement of the media nozzle 30 can preferably be stopped and started at each height. However, the removal of media during a movement of the media nozzle 30 is preferably not possible for safety reasons. This is also provided for by the control already mentioned in conjunction with the force sensor, which is not explicitly depicted in the Figures.

1. A media supply device for the barrier-free, selective supplying of at least one school or laboratory workspace with laboratory media, comprising a body and numerous fittings that can be adjusted in terms of height in relation to the body, and coupled thereto, wherein the coupling between the fittings and the body is such that the fittings can rotate about at least one oblique axis of rotation deviating from a horizontal and vertical axis of rotation.

2. The media supply device according to claim 1, wherein the fittings can rotate about at least one horizontal, at least one vertical, and numerous oblique axes of rotation.

3. The media supply device (100) according to claim 2, wherein the fittings can move in the manner of a nozzle movement.

4. The media supply device according to claim 2, wherein the fittings can be adjusted to numerous predetermined heights in relation to the body.

5. The media supply device according to claim 4, wherein the fittings can be adjusted in terms of height in relation to the body in a continuous manner.

6. The media supply device according to claim 2, wherein the rotatability of the fittings is possible at every height.

2. The media supply device according to claim 2, wherein the fittings are coupled to the body in a non-tensioned manner.

8. The media supply device according claim 2, wherein the fittings are accommodated in a housing, which is coupled to the body.

9. The media supply device according to claim 8, wherein the body has a cavity, in which the housing can be accommodated at least in part.

10. The media supply device according to claim 8, wherein the housing and the body are coupled by means of numerous annular elements, wherein adjacent annular elements are rotatably connected to one another.

11. The media supply device according to claim 10, wherein the rotatability of adjacent annular elements is achieved by means of a ball and socket joint.

12. The media supply device according to claim 10, wherein the numerous annular elements form a closed sheath.

13. The media supply device according to claim 10, wherein the fittings are connected to the laboratory media lines in a fluid and/or electricity conducting manner, which run inside the numerous annular elements.

14. The media supply device according to claim 10, wherein the body has an opening, through which at least a portion of the numerous annular elements can move.

15. The media supply device according to claim 10, wherein a chain is accommodated in the body, which is flange connected to an annular element, and in that the fittings are adjusted in terms of height by means of a horizontal movement of the chain.

16. The media supply device according to claim 1, furthermore comprising a force sensor, which detects a force acting on the fittings, wherein, if the detected force exceeds a predetermined threshold value, the laboratory media supply to the fittings is interrupted.

17. The media supply device according to claim 1, wherein the body is designed to be attached to a ceiling or a wall of a room.

18. The media supply device according to claim 1, wherein the fittings comprise at least two, preferably three or four or five or six or seven or eight or nine or ten laboratory media fittings, which are selected from the group composed of gas, pure-gas, water, compressed air, electricity, EDP, multimedia, light, vacuum and exhaust air fittings.
